(19) United States
(12) Patent Application Publication
(10) Pub. No.: US 2009/0299778 A1
(43) Pub. Date: Dec. 3, 2009

(54) SYSTEM AND METHOD OF PROVIDING TRAVEL SERVICE LISTINGS

(76) Inventor: CHARLES GRAHAM, Orlando, FL (US)

Correspondence Address: McKinney Law, LLC, 121 S. Orange Ave, Suite 1500, Orlando, FL, 32801, US

(21) Appl. No.: 12/346,964

(22) Filed: Dec. 31, 2008

Related U.S. Application Data
(60) Provisional application No. 61/058,181, filed on Jun. 2, 2008.

(51) Int. Cl. G06Q 10/00; G06Q 50/00

(52) U.S. Cl. 705/5

(57) ABSTRACT

A system and method of providing travel service listings is disclosed. In a particular embodiment, the method includes receiving a request for a particular travel related service and searching a database for at least one travel provider that provides the particular travel related service requested. The method further includes generating a travel service listing via a search of the database wherein the database associating at least one particular travel provider of the requested travel related service and identifying an assigned protocol of the at least one particular travel provider. In addition, the assigned protocol contemporaneously indicating an ability of the at least one particular travel provider to satisfy a plurality of predetermined standards.

### I. CROSS REFERENCE TO RELATED APPLICATIONS

This application claims the benefit of U.S. Provisional Application No. 61/058,181 filed Jun. 2, 2008. The disclosure of the provisional application is incorporated herein by reference.

### II. FIELD

The present disclosure is generally related to a system and method of providing travel service listings.

### III. DESCRIPTION OF RELATED ART

Eco-conscious travel involves a wide range of options and all centered on the idea of preserving the planet so that the beautiful places we visit will still be around for our children to see. As eco-consciousness grows, travelers are finding out that even things that may seem small, for example recycling programs, using Energy Star Appliances, or simply re-using towels in their hotel room, can make a significant difference in the long run. However, it is often difficult for consumers to be eco-conscious while traveling. Accordingly, what is needed is a system and method for rating travel services that informs a consumer of the eco-consciousness of a particular travel service provider so that the consumer can make an eco-conscious choice when making travel arrangements.

Another shortcoming of the current eco-conscious travel industry is that there are not always eco-conscious (i.e., “green”) travel options in every city and customers do not always have the financial freedom to pay more for eco-conscious travel. Accordingly, what is needed in the art is a system and method that is easy for a traveler to use to book competitive eco-conscious travel arrangements on a budget.

However, in view of the prior art at the time the present invention was made, it was not obvious to those of ordinary skill in the pertinent art how the identified needs could be fulfilled.

### IV. SUMMARY

In a particular embodiment, a method of providing travel service listings is disclosed. The method includes receiving a request for a particular travel related service and searching a database for at least one travel provider that provides the particular travel related service requested. In addition, the method includes generating a travel service listing via a search of the database wherein the database associating at least one particular travel provider of the requested travel related service. The method further includes identifying an assigned protocol of the at least one particular travel provider, wherein the assigned protocol contemporaneously indicating an ability of the at least one particular travel provider to satisfy a plurality of predetermined standards.

In another particular embodiment, a processor readable medium storing processor instructions is disclosed. The processor instructions are executable to cause a processor to receive a request for a particular travel related service and search a database for at least one travel provider that provides the particular travel related service requested. The processor instructions are also executable to cause the processor to generate a travel service listing via a search of the database wherein the database associating at least one particular travel provider of the requested travel related service and identifying an assigned protocol of the at least one particular travel provider and wherein the assigned protocol contemporaneously indicating an ability of the at least one particular travel provider to satisfy a plurality of predetermined standards.

A particular advantage provided by disclosed embodiments is that the travel service listing provides an assigned protocol that relates to the impact of patronizing that particular travel provider will have on the environment.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of a particular illustrative embodiment of a method of providing travel related listings;

FIG. 2 is a flow chart of a particular illustrative embodiment of a system of providing travel related listings;

FIG. 3 is a table of predetermined standards and associated values for a particular embodiment of a system and method of providing travel related listings;

FIG. 4 is a table of assigned protocols associated with aggregate values of the predetermined standards for a particular embodiment of a system and method of providing travel related listings;

FIG. 5 is a graphical user interface that can be used for requesting a travel related service;

FIG. 6 is a representation of a display showing a travel related listing in accordance with a particular embodiment of the system and method of providing travel related listings; and

FIG. 7 is a block diagram of an illustrative embodiment of a general computer system.

### VI. DETAILED DESCRIPTION

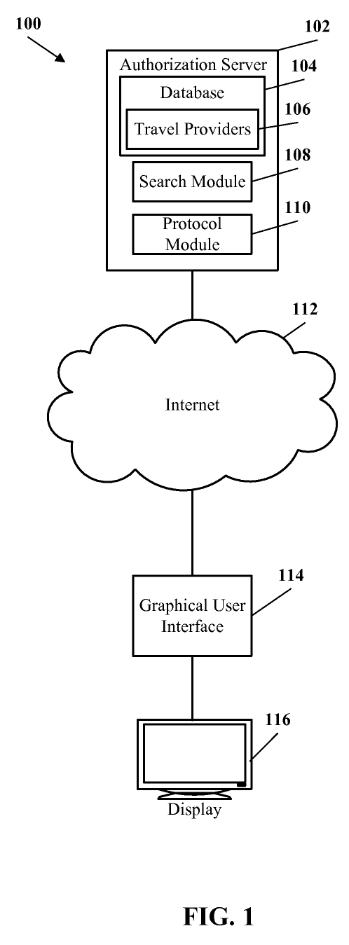

Referring to FIG. 1, a particular illustrative embodiment of a system of providing travel related listings is depicted and generally designated 100. The system 100 includes an authorization server 102 to determine whether the graphical user interface 114 is authorized to access the database 104. The graphical user interface 114 may access the authorization server 102 via Internet 112. The database 104 may include information regarding particular travel providers 106. The authorization server 102 also includes a search module 108 that may perform various functions, including receiving a search request for a particular type of travel provider, determining the travel providers that match the request, and sending the results to a protocol module 110. The protocol module 110 may process the results, including identifying an assigned protocol of at least one travel provider from the results. The protocol module 110 may also store a table of predetermined standards and associated values. In addition, protocol module 110 may also include a table of assigned protocols associated with aggregate values of the predetermined standards. The search module 108 and protocol module 110 may be implemented in hardware, firmware, software, other programmable logic, or any combination thereof.

In operation, a request for a travel provider is entered using the graphical user interface 114. For example, a user may request all airlines that offer flights on certain days to a particular city. The authorization server 102 may verify that the user is authorized to access the database 104. After authorizing the user, the search module 108 identifies the appropriate travel providers 106 that match the request and displays the results on display 116 of the travel providers and assigned protocols as processed contemporaneously by the protocol module.

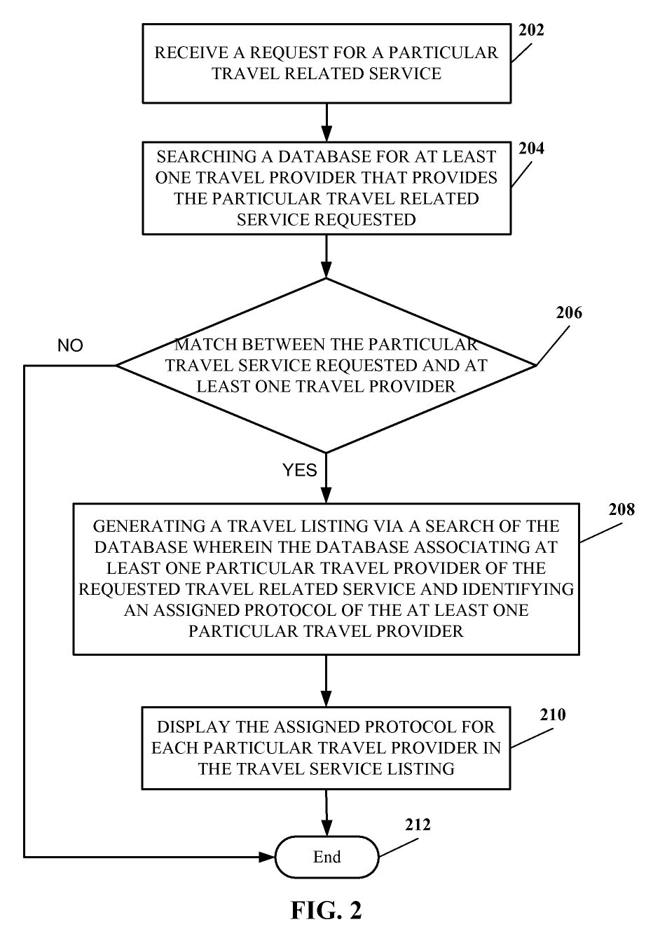

FIG. 2 is a flow chart of a particular illustrative embodiment of a system of providing travel related listings. One or more servers, such as the authorization server 102 of FIG. 1, may execute the method. At 202, a request is received for a particular travel related service. Proceeding to 204, a database is searched for at least one travel provider that provides the particular travel related service requested. Moving to 206, if no match is made between the particular travel service requested and at least one travel provider, then the method ends at 212. If a match is made between the particular travel service requested and at least one travel provider at 206, then at 208, a travel listing is generated via a search of the database wherein the database associating at least one particular travel provider of the requested travel related service and identifying an assigned protocol of the at least one particular travel provider. The assigned protocol is displayed, at 210, for each particular travel provider in the travel service listing.

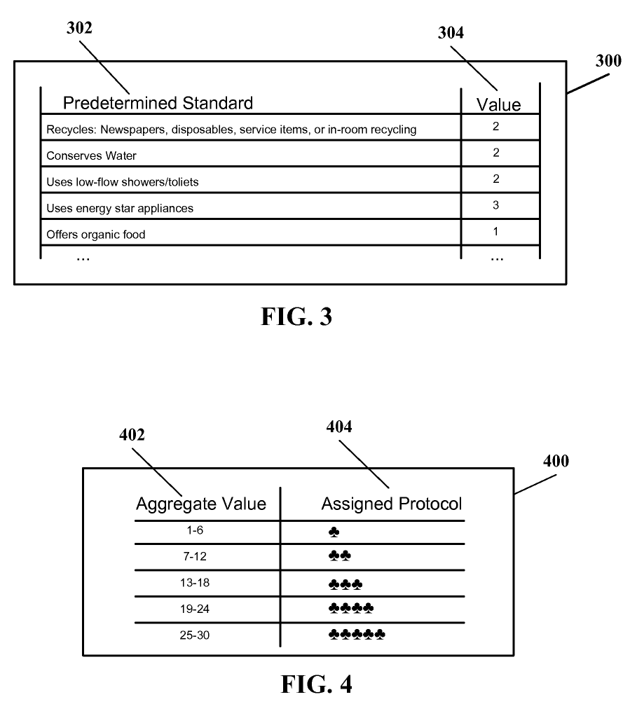

Referring now to FIG. 3, a table 300 may be stored in the protocol module of FIG. 1 to indicate predetermined standards 302 are assigned values 304 for each predetermined standard satisfied by a travel service provider. For example, a hotel that satisfies the predetermined standard 302 of “recycles: newspaper, disposables, service items, or in-room recycling” is assigned a points value of “2.” A hotel that satisfies the predetermined standard 302 of “offers organic food” is assigned a points value of “1.” Thus, the predetermined standards are weighted so that one predetermined standard may affect an assigned protocol of a travel service provider more than a second predetermined standard. A predetermined standard with a point value of “3” requires significantly more effort for a travel provider to achieve than a predetermined standard of “1.” The predetermined standards 302 illustrated in FIG. 3 are not intended to be limited to those predetermined standards shown therein, but are provided for examples so that the table 300 may include any number of predetermined standards 302. Likewise, the points value assigned to each predetermined standard is not intended to be limited, but may include any value desired.

An assigned protocol 400 for each travel service provider is determined by totaling the value 304 of all the predetermined standards 302 that a travel service provider satisfies to calculate an aggregate value 402, as shown in FIG. 4. A range of aggregate values 402 determines the assigned protocol 404. For example, an aggregate value 402 of “1-6” contemporaneously indicates an assigned protocol 404 of a travel provider that satisfies a relatively low threshold of predetermined standards 302. An aggregate value 402 of “25-30” contemporaneously indicates a travel provider that satisfies a relatively high threshold of predetermined standards 302. In operation, a user may be objectively informed of the selected travel service provider's “Green” rating. The term “Green” as used herein refers in general to the minimization of impacts to the environment.

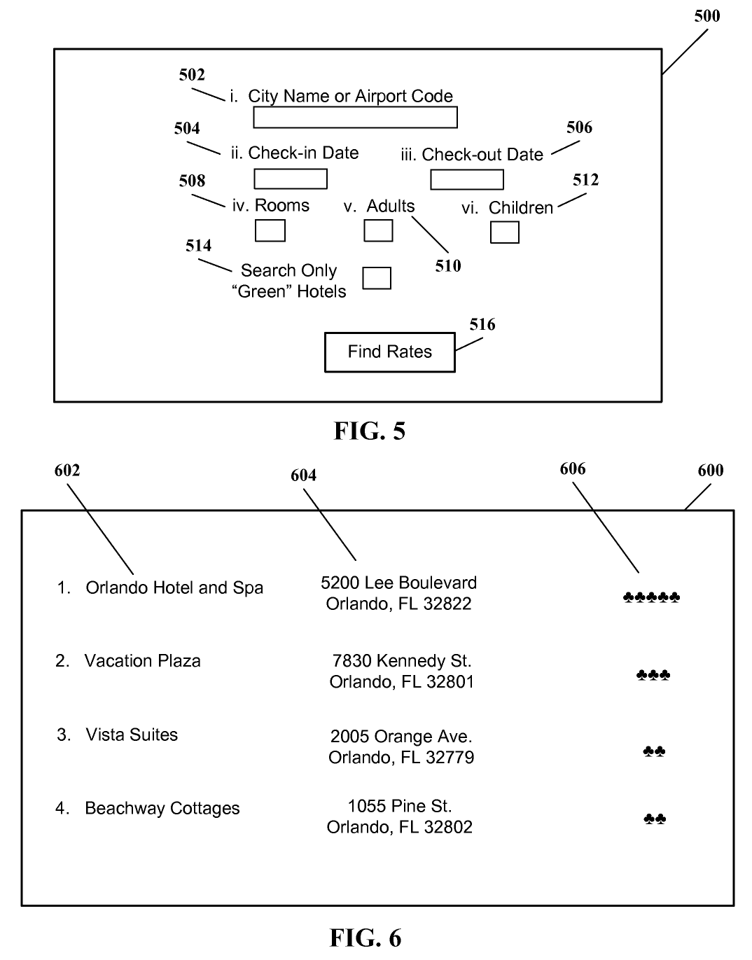

A graphical user interface (“GUI”) 500, may be used to enter the requested travel arrangements as shown in FIG. 5. For example, the travel arrangements may include information of the city name or airport code 502, check-in date 504, check-out date 506, number of rooms 508, number of adults 510, number of children 512, and whether to search only “Green” hotels 514, or any combination thereof. A “Green” hotel may be a hotel that satisfies a minimum threshold of predetermined standards. Once the data has been entered using the GUI 500, the system begins processing the travel request data to match the consumer with available travel arrangement and visually displays the results, as shown in FIG. 6.

Referring now to FIG. 6, a travel related listing is displayed 600 showing a number of hotels 602 that match the particular travel related service requested. A physical location address 604 of each hotel 602 may also be provided, in addition to website addresses and reservation phone numbers. As described above, the travel service providers (e.g., hotels) earn points by satisfying the predetermined standards such as incorporating recycling programs, to using Energy Star Appliances, to landscaping with native plant gardens. An assigned protocol 606 (i.e., “Green” score) may be included in the results 600 displayed. For example, as shown in FIG. 6, the Orlando Hotel and Spa's assigned protocol is five “trees” 606 and Vacation Plaza's assigned protocol is three “trees.” Thus, Orlando Hotel and Spa satisfies a higher threshold of predetermined standards than the Vacation Plaza.

A “Search Only for ‘Green’ Hotels” feature allows hotels and travel services to be sorted by their respective assigned protocol. For example, a consumer may objectively evaluate a hotel's and/or travel service provider's impact to the environment based on the respective assigned protocol and help decide whether that consumer will stay at that hotel and make the travel arrangements. In addition, when the results are sorted by the assigned protocol, the travel service providers may automatically appear in order of their assigned protocol (i.e., ‘“Green” score’) starting with the highest at the top and ranging down to the lowest. The assigned protocol is designed to show customers exactly what steps individual travel providers are taking to protect the planet.

Even though some hotels may only be assigned one “tree” at a particular point in time, the system and method for providing travel related listing provides incentives for travel service providers to continue to improve their assigned protocol and make positive changes for the planet. A hotel may also achieve a “Green Hotel Certification” when the highest level assigned protocol is reached. For example, when the aggregate value of a hotel is between 25 and 30, as shown in FIG. 4, the hotel achieves an assigned protocol of five “trees.” Upon independent verification that the hotel has satisfied the respective predetermined standards, the hotel receives a “Green Hotel Certification.” The hotel may then advertise its “Green Hotel Certification,” which provides immediate credibility and recognition.

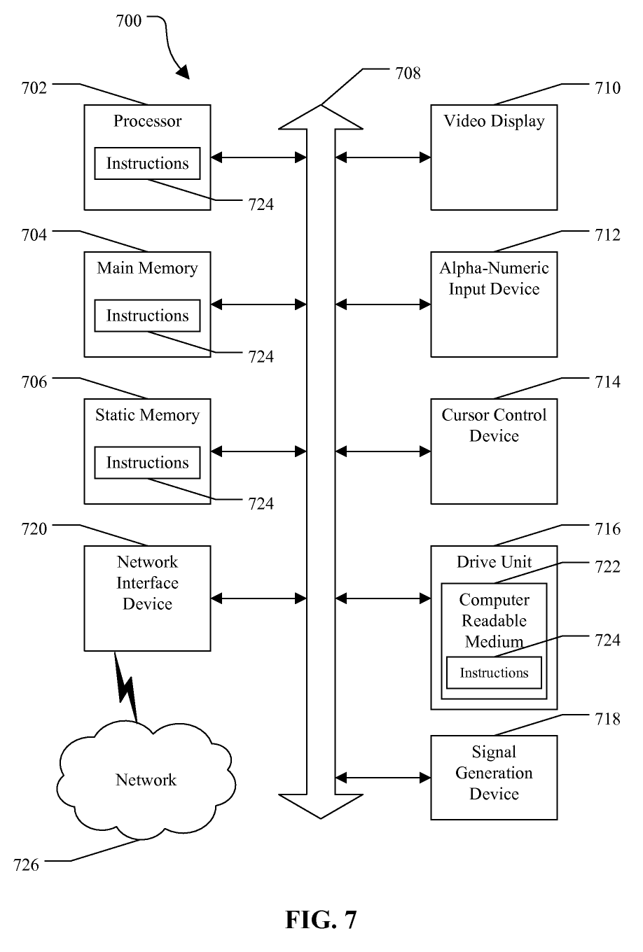

Referring to FIG. 7, an illustrative embodiment of a general computer system is shown and is designated 700. The computer system 700 can include a set of instructions that can be executed to cause the computer system 700 to perform any one or more of the methods or computer based functions disclosed herein. The computer system 700, or any portion thereof, may operate as a standalone device or may be connected, e.g., using a network, to other computer systems or peripheral devices, including an authorization server as shown in FIG. 1.

In a networked deployment, the computer system may operate in the capacity of a server, such as a video server or application server, or a media device. The computer system 700 can also be implemented as or incorporated into various devices, such as a personal computer (PC), a personal digital assistant (PDA), a mobile device, a palmtop computer, a laptop computer, a desktop computer, a communications device, a wireless telephone, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics-processing unit (GPU), or both.

Moreover, the computer system 700 can include a main memory 704 and a static memory 706 that can communicate with each other via a bus 708. As shown, the computer system 700 may further include a video display unit 710, such as a liquid crystal display (LCD), a flat panel display, a solid-state display, or a cathode ray tube (CRT). Additionally, the computer system 700 may include an input device 712, such as a keyboard, and a cursor control device 714, such as a mouse. The computer system 700 can also include a disk drive unit 716, a signal generation device 718, such as a speaker or remote control, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope possible consistent with the principles and novel features as defined by the following claims.

What is claimed is:

1. A method comprising:
receiving a request for a particular travel related service;
searching a database for at least one travel provider that provides the particular travel related service requested; and
generating a travel service listing via a search of the database wherein the database associating at least one particular travel provider of the requested travel related service and identifying an assigned protocol of the at least one particular travel provider;
wherein the assigned protocol contemporaneously indicating an ability of the at least one particular travel provider to satisfy a plurality of predetermined standards.

2. The method of claim 1, further comprising displaying the assigned protocol for each particular travel provider in the travel service listing.

3. The method of claim 1, wherein a standard of the predetermined standards is recycling materials.

4. The method of claim 1, wherein a standard of the predetermined standards is water-conservation.

5. The method of claim 1, wherein a standard of the predetermined standards is energy-conservation appliances.

6. The method of claim 1, wherein a standard of the predetermined standards is organic food.

7. The method of claim 1, further comprising maintaining the database to contemporaneously update the assigned protocol of each particular travel provider.

8. The method of claim 1, further comprising determining an aggregate value of two or more predetermined standards.

9. The method of claim 1, wherein the assigned protocol comprises a symbol.

10. The method of claim 1, wherein a value of a first standard is greater than a value of a second standard of the plurality of predetermined standards.

11. A processor readable medium having processor instructions that are executable to cause a processor to:
receive a request for a particular travel related service;
search a database for at least one travel provider that provides the particular travel related service requested;
generate a travel service listing via a search of the database wherein the database associating at least one particular travel provider of the requested travel related service and identifying an assigned protocol of the at least one particular travel provider; and
wherein the assigned protocol contemporaneously indicating an ability of the at least one particular travel provider to satisfy a plurality of predetermined standards.

12. The processor readable medium of claim 11, wherein the processor executable instructions are further executable to display the assigned protocol for each particular travel provider in the travel service listing.

13. The processor readable medium of claim 11, wherein a standard of the predetermined standards is recycling materials.

14. The processor readable medium of claim 11, wherein a standard of the predetermined standards is water-conservation.

15. The processor readable medium of claim 11, wherein a standard of the predetermined standards is energy-conservation appliances.

16. The processor readable medium of claim 11, wherein a standard of the predetermined standards is organic food.

17. The processor readable medium of claim 11, wherein the processor executable instructions are further executable to maintain the database to contemporaneously update the assigned protocol of each particular travel provider.

18. The processor readable medium of claim 11, wherein the processor executable instructions are further executable to determine an aggregate value of two or more predetermined standards.

19. The processor readable medium of claim 11, wherein the assigned protocol comprises a symbol.

20. The processor readable medium of claim 11, wherein a value of a first standard is greater than a value of a second standard of the plurality of predetermined standards.
